(19) United States
(12) Patent Application Publication
(10) Pub. No.: US 2019/0057453 A1
(43) Pub. Date: Feb. 21, 2019

(54) APPARATUS AND SYSTEM FOR USAGE-BASED INSURANCE USING VEHICLE STATUS INFORMATION AND METHOD THEREOF

(71) Applicant: CENTER FOR INTEGRATED SMART SENSORS FOUNDATION, Daejeon (KR)

(72) Inventors: Jin Young Yang, Daejeon (KR); Jae Hyung Park, Daejeon (KR)

(21) Appl. No.: 16/104,655

(22) Filed: Aug. 17, 2018

(30) Foreign Application Priority Data
Aug. 17, 2017 (KR) 10-2017-0104179

(51) Int. Cl. G06Q 40/08; H04L 29/06

(52) U.S. Cl. CPC G06Q 40/08; H04L 63/0853

(57) ABSTRACT

Disclosed are a usage-based insurance terminal device selecting a vehicle status information corresponding to an insurance information of a vehicle and transmitting the selected vehicle status information to an external server, a system, and a method thereof. A user (a driver or an owner of the vehicle) gets discount on car insurance premium, and an insurance company provides a variety of insurance products based on the vehicle status information. In addition, since a customized service for the usage-based insurance is provided to the user or the insurance company when events occur, the events may be processed quickly.

### CROSS-REFERENCE TO RELATED APPLICATIONS

A claim for priority under 35 U.S.C. § 119 is made to Korean Patent Application No. 10-2017-0104179 filed on Aug. 17, 2017, in the Korean Intellectual Property Office, the entire contents of which are hereby incorporated by reference.

### BACKGROUND

Embodiments of the inventive concepts described herein relate to an apparatus and a system for usage-based insurance using vehicle status information and a method thereof, and more particularly, relate to a technology for selecting vehicle status information corresponding to insurance information of a vehicle and transmitting the vehicle status information to an external server.

There are a variety of discounts on car insurance policy. For instance, a direct insurance plan, i.e., an online insurance plan, is about 15% to about 17% cheaper than an offline insurance plan, which is purchased offline, and having a car black box installed in a vehicle earns a discount of about 3% to about 5%.

In addition, an additional discount is offered depending on annual mileage. As an example, if the annual mileage is less than 10,000 km, the smaller the mileage, the more the discounts, and it is possible to settle the discount calculation after a predetermined period.

Besides, available car insurance discount options, such as a special discount option for children and a special discount option for baby-in-car, vary widely from insurance company to insurance company. Hyundai M & F insurance provides discounts on accident and emergency notification devices linked to Hyundai Motor BlueLink or Kia Motor UVO. Also, DB insurance provides discounts when using Smart Usage-Based Insurance (UBI) smart driving in a smartphone T-map.

That is, insurance products that are linked to discounts through devices of a specific company exist, but terminal devices that are able to be linked to discount products and used by all insurers have not been commercialized.

Korean Patent Publication no. 10-2013-0106155 relates to a black box data service system for a vehicle and provides various services linked to insurers using black box information. In addition, Korean Patent Publication no. 10-2013-0026213 relates to a system and a method for receiving vehicle driving information using mobile terminal and provides vehicle driving information and driver information to insurers.

However, since Korean Patent Publication no. 10-2013-0106155 and Korean Patent Publication no. 10-2013-0026213 provide various services linked to insurers using black box and mobile terminal and perform analyzing on vehicle driving information, driver information, and vehicle driving pattern, there is a limitation that it is required to collect and provide vast amounts of vehicle information and driver information in addition to information for the insurance policy of a corresponding vehicle.

### PRIOR ART REFERENCE

### Patent Reference

Korean Patent Publication No. 10-2013-0106155 (published on Sep. 27, 2013), “Black Box Information Service System for Vehicle”

Korean Patent Publication No. 10-2013-0026213 (published on Mar. 13, 2013), “Method for Receiving Vehicle Information using Mobile Terminal”

### SUMMARY

Embodiments of the inventive concepts provide a UBI terminal device and a system, which are capable of transmitting customized vehicle status information corresponding to a vehicle insurance of a vehicle that is insured to a vehicle insurance company in real time and providing a service for a usage-based insurance depending on occurrence of events, and a method thereof.

One aspect of embodiments of the inventive concept is directed to provide a usage-based insurance terminal device including an authentication processor obtaining an insurance information corresponding to a vehicle from a mobile device based on an authentication result through the mobile device in the vehicle and a data transmitter selecting a vehicle status information needed for a service for a usage-based insurance of the vehicle based on the insurance information and transmitting the vehicle status information to an external operational data server.

The data transmitter transmits the vehicle status information and a vehicle identification number, which are collected from an on-board diagnostics terminal in the vehicle after being connected to the on-board diagnostics terminal, to the mobile device paired therewith.

The mobile device transmits the vehicle status information and the vehicle identification number to an authentication server and executes an authentication process based on an identification information provided from the authentication server.

The authentication processor receives at least one of the insurance information of the vehicle that is insured, the identification information, and a device information of the mobile device from the mobile device through the authentication server based on the authentication result.

The insurance information is an information related to an insurance of the vehicle insured with an insurance company, and the service for the usage-based insurance includes a service for maintaining and managing the insurance corresponding to the insurance information or a service provided to the vehicle when events occur.

The data transmitter selects an information needed for the service for the usage-based insurance among the vehicle status information collected from an on-board diagnostics terminal in the vehicle based on the insurance information and transmits the selected vehicle status information to the operational data server.

The data transmitter generates the selected vehicle status information and a driving information and transmits the selected vehicle status information and the driving information to the operational data server according to a set transmission cycle based on the insurance information provided from the mobile device and an identification information.

Another aspect of embodiments of the inventive concept is directed to provide a usage-based insurance system including a usage-based insurance terminal device executing an authentication process with a mobile device in a vehicle, selecting a vehicle status information needed for a service for a usage-based insurance of the vehicle from an insurance information according to the authentication result, and transmitting the selected vehicle status information to an external operational data server, the mobile device paired with the usage-based insurance terminal device to transmit the authentication result and the insurance information, an authentication server extracting the insurance information using the vehicle status information and a vehicle identification number of the vehicle, which are provided from the mobile device, and the operational data server receiving the selected vehicle status information needed for the service for the usage-based insurance from the usage-based insurance terminal device.

The mobile device transmits the vehicle status information and the vehicle identification number, which are provided from the usage-based insurance device, to the authentication server and executes the authentication process based on an identification information received according to a review of the authentication server.

The mobile device receives the insurance information of the vehicle that is insured from the authentication server based on the authentication result and transmits at least one of the received insurance information, the identification information, and a device information of the mobile device to the usage-based insurance terminal device.

The usage-based insurance terminal device selects an information needed for the service for the usage-based insurance among the vehicle status information collected from an on-board diagnostics terminal in the vehicle based on the insurance information provided from the mobile device and transmits the selected vehicle status information to the operational data server.

The usage-based insurance terminal device generates the selected vehicle status information and a driving information and transmits the selected vehicle status information and the driving information to the operational data server according to a set transmission cycle based on the insurance information provided from the mobile device and an identification information.

Still another aspect of embodiments of the inventive concept is directed to provide an operation method of a usage-based insurance terminal device including a first operation for obtaining an insurance information corresponding to a vehicle from a mobile device based on an authentication result through the mobile device in the vehicle, and a second operation for selecting a vehicle status information needed for a service for a usage-based insurance of the vehicle based on the insurance information to transmit the vehicle status information to an external operational data server.

The first operation includes pairing with the mobile device, transmitting the vehicle status information and a vehicle identification number, which are collected from an on-board diagnostics terminal in the vehicle after being connected to the on-board diagnostics terminal, to the mobile device, and receiving at least one of the insurance information of the vehicle that is insured, an identification information, and a device information of the mobile device from the mobile device based on the authentication result.

The authentication result is obtained by an authentication process between the mobile device and the authentication server based on the vehicle status information and the vehicle identification number.

The second operation includes selecting an information needed for the service for the usage-based insurance among the vehicle status information collected from an on-board diagnostics terminal in the vehicle based on the insurance information provided from the mobile device, and transmitting the selected vehicle status information to the operational data server.

The selecting of the needed information includes generating the selected vehicle status information and a driving information according to a set transmission cycle based on the insurance information and an identification information, which are provided from the mobile device.

According to embodiments of the present inventive concept, when the usage-based insurance terminal device is used, a user (a driver or an owner of the vehicle) is able to get discounts on car insurance, and an insurance company is capable of providing a variety of insurance products based on the vehicle status information. In addition, since a customized service based on occurrence of events for the usage-based insurance is provided to the user, the events are processed quickly.

Further, according to embodiments of the present inventive concept, the mobile device of the driver is paired with the UBI terminal device every time the car is driven, and thus a personalized service is provided.

Further, the driver is identified using the mobile device of the driver in accordance with the insurance policy, such as a couple-limited policy and family-limited policy, and the vehicle status information are stored for each driver to provide a customized usage-based insurance service.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram explaining a configuration of a UBI terminal device according to an exemplary embodiment of the present inventive concept;

FIG. 2 is a block diagram showing a UBI terminal device according to an exemplary embodiment of the present inventive concept;

FIG. 3 is a view showing an application example of a UBI terminal device according to an exemplary embodiment of the present inventive concept;

FIG. 4 is a view explaining a configuration of a UBI system according to an exemplary embodiment of the present inventive concept;

FIG. 5 is a view showing an operation flow between a UBI terminal device, a mobile device, an authentication server, and an operational data server according to an exemplary embodiment of the present inventive concept.

FIG. 6 is a flowchart showing an operation method of a UBI terminal device according to an exemplary embodiment of the present inventive concept.

### DETAILED DESCRIPTION

Hereinafter, embodiments of the present inventive concept will be described in detail with reference to accompanying drawings. However, the present inventive concept is not limited or restricted to the embodiments. In addition, same reference numerals in each drawing denote the same elements.

In addition, the terms (terminology) that are used herein as a term used to adequately represent the preferred embodiments of the present inventive concept, which may vary according to the viewer, the operator's intention or custom of the field to which the present inventive concept pertains. Therefore, the definitions of the terms should be made according to throughout the present specification.

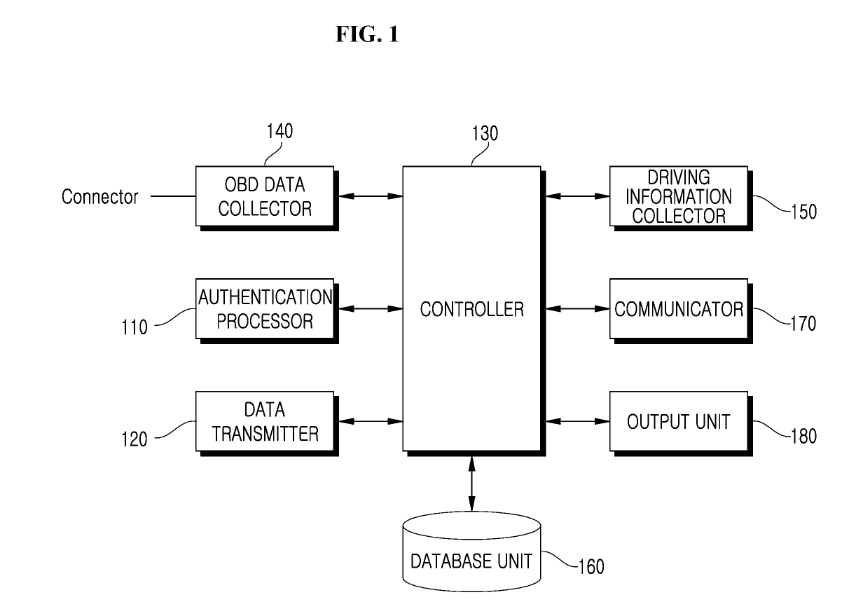

FIG. 1 is a block diagram explaining a configuration of a UBI terminal device 100 according to an exemplary embodiment of the present inventive concept.

Referring to FIG. 1, the UBI terminal device 100 according to the exemplary embodiment of the present inventive concept selects vehicle status information according to insurance information corresponding to a vehicle and transmits the insurance information to an external operational data server.

The UBI terminal device 100 according to the exemplary embodiment of the present inventive concept includes an authentication processor 110 and a data transmitter 120.

The UBI terminal device 100 according to the exemplary embodiment of the present inventive concept may be connected to an on-board diagnostics (OBD) terminal in the vehicle through an OBD data collector 140 to collect OBD data (hereinafter, referred to as “vehicle status information”).

For instance, the UBI terminal device 100 according to the exemplary embodiment of the present inventive concept may be connected to the OBD terminal in the vehicle using a connector including a plurality of pin arrangements and a plurality of communication methods and may collect the vehicle status information generated at the OBD terminal by running the vehicle.

In this case, the collected vehicle status information may include a standard PID (parameter ID) related to a vehicle fault diagnosis or a non-standard PID related to a turn signal, a gear position, a seatbelt usage, a window manipulation, and a lamp manipulation.

According to embodiments, the UBI terminal device 100 according to the exemplary embodiment of the present inventive concept may include an on-board diagnostics (OBD) terminal unit or an OBD scanner connected to the OBD terminal.

Further, the UBI terminal device 100 according to the exemplary embodiment of the present inventive concept may be installed inside the vehicle to sense not only operation information in the vehicle but also vehicle diagnostic information including sensor information and driving information.

A driving information collector 150 of the UBI terminal device 100 according to the exemplary embodiment of the present inventive concept may collect the driving information according to the running of the vehicle, and the driving information may include, for example, at least one of location information, speed information, and mileage information of the vehicle, which are obtained by using a GPS module.

Referring to FIG. 1, the authentication processor 110 of the UBI terminal device 100 according to the exemplary embodiment of the present inventive concept obtains insurance information corresponding to the vehicle from a mobile device based on an authentication result through the mobile device in the vehicle.

In this case, the authentication processor 110 may obtain the insurance information, which corresponds to an insurance policy of the vehicle that is insured, from the mobile device based on the authentication result according to an authentication process between the mobile device installed in the vehicle and an external authentication server.

In more detail, the UBI terminal device 100 according to the exemplary embodiment of the present inventive concept may transmit the vehicle status information and a vehicle identification number (VIN), which are collected through the OBD terminal in the vehicle, to the mobile device paired therewith. In this case, the vehicle identification number may be an identifying code assigned to the vehicle. Then, the mobile device may transmit the vehicle status information and the vehicle identification number to the authentication server and may perform the authentication process based on identification information (policy ID) provided from the authentication server. That is, the authentication process may be a process to determine whether the vehicle has an insurance policy of an insurance company.

The authentication processor 110 may receive at least one of the insurance information of the vehicle that is insured, the identification information, and device information of the mobile device from the mobile device through the authentication server based on the authentication result through the mobile device. In this case, the insurance information may be information related to the insurance of the vehicle insured with the insurance company, and the service for the usage-based insurance may include a service for maintaining and managing the insurance corresponding to the insurance information or a service provided to the vehicle when events occur. In addition, the insurance company may include the authentication server and the operational data server.

In the exemplary embodiment, the identification information corresponds to information about the insurance that is an insurance policy of the vehicle insured, and the authentication processor 110 according to the exemplary embodiment of the present inventive concept may identify the insurance information using the identification information.

The data transmitter 120 selects the vehicle status information needed for the usage-based insurance (UBI) service of the vehicle based on the insurance information and transmits the vehicle status information to the external operational data server.

For example, the data transmitter 120 may select the vehicle status information required for the usage-based insurance (UBI) service, i.e., the insurance service for the insured vehicle, among the vehicle status information collected from the OBD terminal in the vehicle based on the insurance information and may transmit the vehicle status information to the operational data server. In this case, the data transmitter 120 may generate the selected vehicle status information and the driving information collected by the driving information collector 150 based on the insurance information and the identification information (ID), which are provided from the mobile device, and may transmit the selected vehicle status information and the driving information to the operational data server according to a set transmission cycle required by the usage-based insurance service of the insured vehicle.

Referring to FIG. 1 again, the UBI terminal device 100 according to the exemplary embodiment of the present inventive concept may further include a controller 130, a database unit 160, a communicator 170, and an output unit 180.

However, FIG. 1 merely shows an example of the UBI terminal device 100, and the UBI terminal device 100 may include more or fewer components than components shown in FIG. 1 and may include a configuration or an arrangement, which couples two or more components to each other or includes different components from each other.

In addition, the components shown in FIG. 1 may be implemented by hardware, software, or a combination of both of the hardware and the software including an integrated circuit specialized for one or more signal processing or application, and the terms “-er, -or, and unit” used herein for the components may mean units for processing at least one function or operation, which may be implemented as hardware, software, or a combination of hardware and software.

The controller 130 may include a processor, a central processing unit, an application processor, or a communication processor. For example, the controller 130 may control an operation of the authentication processor 110, the data transmitter 120, the OBD data collector 140, the driving information collector 150, the database unit 160, the communicator 170, and the output unit 180.

According to embodiments, the controller 130 may drive an operating system or an application program to control a plurality of hardware or software components connected to the controller 130 and may process and compute a variety of data. For example, the controller 130 may be implemented with a System on Chip (SoC), may load and process instructions or data, which are received from at least one of other components (e.g., a nonvolatile memory), and may store result data in the nonvolatile memory.

The database unit 160 may associate the vehicle, the mobile device, and the insurance information corresponding to the vehicle with each other to store and maintain the associated information. For example, the database unit 160 may store the insurance information, the identification information, and the device information of the mobile device for each vehicle identification number of the vehicles therein, to be matched with each other. In addition, the database unit 160 may store driver information about drivers according to the vehicle identification number of the vehicles and the device information of the mobile device corresponding to the driver information to be matched with each other.

The communicator 170 may include a LoRa module and a Bluetooth and may transmit and receive data to and from the mobile device, the external authentication server, and the operational data server using the LoRa module and the Bluetooth.

According to embodiments, the communicator 170 may communicate with a wireless network such as a cellular phone network, a wireless local area network (wireless LAN), and/or a metropolitan area network (MAN), a network such as an intranet and/or an internet called a world wide web (WWW), and other devices by a wireless communication.

In the exemplary embodiment, the wireless communication may include a protocol for email, such as a GSM (Global System for Mobile Communications), an EDGE (Enhanced Data GSM Environment), a W-CDMA (wideband code division multiple access), a CDMA (code division multiple access), a TDMA (time division multiple access), an (IEEE 802.11a, IEEE 802.11b, IEEE 802.11g and/or IEEE 802.11n) Wi-Fi(Wireless Fidelity), a VoIP(voice over Internet Protocol), a Wi-MAX, an LTE(Long Term Evolution), a Zigbee, a Z-wave, a BLE (Bluetooth Low Energy), a Beacon, an IMAP (Internet Message Access Protocol) and/or a POP(Post Office Protocol), an instant messaging, such as an XMPP (eXtensible Messaging and Presence Protocol), an SIMPLE (Session Initiation Protocol for Instant Messaging and Presence Leveraging Extensions), an IMPS (Instant Messaging and Presence Service), or an SMS(Short Message Service), or a communication protocol that has not yet been developed at the time of filing of the present inventive concept. However, the wireless communication should not be limited to the above, and a plurality of communication standards, protocols, and technologies may be used as the above-described wireless communication.

The output unit 180 may include an audio module, a speaker module, and a vibration module. For example, when the events occur, the output unit 180 may output an alarm sound using the audio module, the speaker module, or a buzzer, may flash a warning light using a light emitting diode (LED), or may generate a vibration using the vibration module. According to embodiments, the UBI terminal device 100 according to the exemplary embodiment of the present inventive concept may provide output information using an output module included in the vehicle when the events occur.

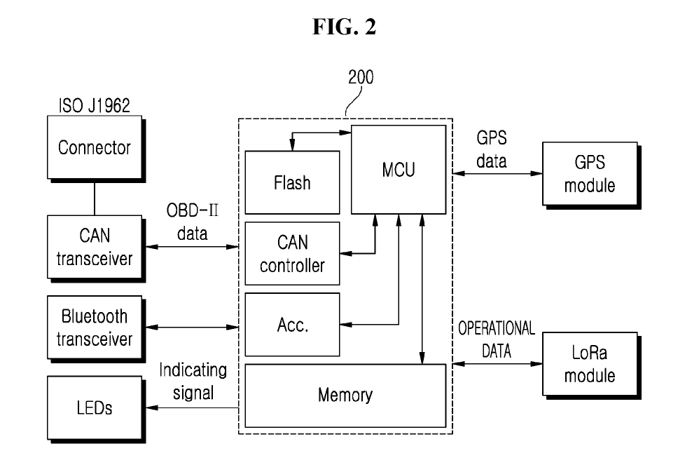

FIG. 2 is a block diagram showing a UBI terminal device 200 according to an exemplary embodiment of the present inventive concept.

Referring to FIG. 2, the UBI terminal device 200 according to the exemplary embodiment of the present inventive concept may include a microcontroller unit (MCU), a flash, a CAN controller, an accelerometer (Acc), and a memory. In this case, the UBI terminal device 200 according to the exemplary embodiment of the present inventive concept may obtain location information of the vehicle from a GPS module, transmit data to the external server through a LoRa module, and communicate with the mobile device through a Bluetooth transceiver. In addition, the UBI terminal device 200 according to the exemplary embodiment of the present inventive concept may collect OBD data of the vehicle using a CAN transceiver and may provide output information using an LED.

For example, the UBI terminal device 200 according to the exemplary embodiment of the present inventive concept may obtain a position of the vehicle through the GPS module and may transmit the position of the vehicle, the events occurring in the vehicle, the vehicle status information, and the driving information to the external server through the LoRa module at low speed. In this case, a user may download and execute an application of a car insurance company of the insured vehicle to the mobile device through an App store, and the application in the mobile device may transmit and receive the data to and from the UBI terminal device 200 through the Bluetooth transceiver of the mobile device.

In the present exemplary embodiment, the data transmitted and received between the application and the UBI terminal device 200 may include the location information of the vehicle, which is obtained from the GPS module, the event information obtained by processing an input to the accelerometer Acc, and the vehicle status information obtained through the OBD.

In addition, the Bluetooth transceiver shown in FIG. 2 is used to link the UBI terminal device 200 according to the exemplary embodiment of the present inventive concept and the mobile device, and the Bluetooth transceiver may be replaced with a wireless personal area network (WPAN) technology capable of bi-directional data transmission, such as a near field communication (NFC). In addition, the LoRa module is a low-cost low power wide area (LPWA) IoT connectivity technology, and the LoRa module may be replaced with other technologies, such as SigFox, LTE-M, or NB-IoT, which is similar thereto.

The UBI terminal device 200 according to the exemplary embodiment of the present inventive concept may communicate smoothly with a GPS satellite and a LoRa network since the UBI terminal device 200 uses the GPS module and the LoRa module, and the UBI terminal device 200 may provide the user with the output information about a current operation through the LED.

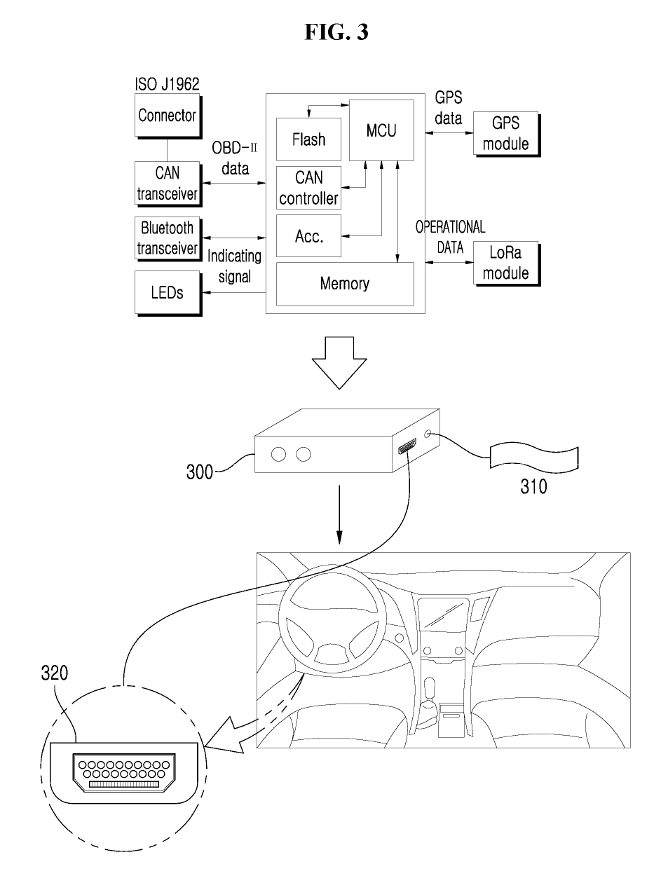

FIG. 3 is a view showing an application example of a UBI terminal device 300 according to an exemplary embodiment of the present inventive concept.

In general, a terminal employing an OBD terminal 320 is installed around the OBD terminal 320. However, it is difficult for the terminal to communicate with the GPS and the LoRa network when the terminal is installed around the OBD terminal 320.

Accordingly, the UBI terminal device 300 according to the exemplary embodiment of the present inventive concept may be located at a position indicated by an arrow and may include a LoRa antenna 310 and the OBD terminal 320, which are connected to the UBI terminal device 300. In this case, it is preferable that the LoRa antenna 310 is attached to a window in flexible form.

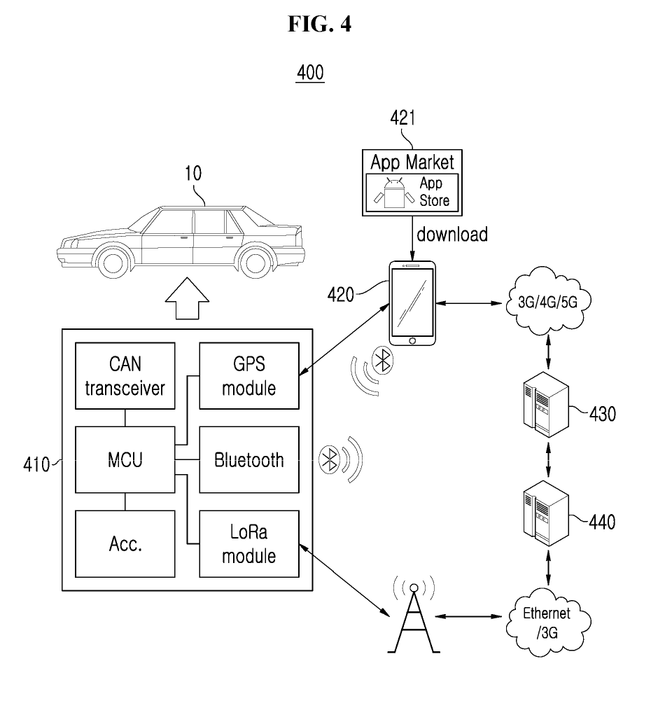

FIG. 4 is a view explaining a configuration of a UBI system 400 according to an exemplary embodiment of the present inventive concept.

Referring to FIG. 4, the UBI system 400 according to the exemplary embodiment of the present inventive concept transmits vehicle status information selected from a UBI terminal device 410 to an operational data server 440 based on an authentication result between an authentication server 430 and a mobile device 420.

To this end, the UBI system 400 according to the exemplary embodiment of the present inventive concept includes the UBI terminal device 410, the mobile device 420, the authentication server 430, and the operational data server 440.

The UBI terminal device 410 performs the authentication process with the mobile device 420 in the vehicle 10 and selects the vehicle status information needed for the usage-based insurance (UBI) service of the vehicle 10 from the insurance information in accordance with the authentication result to transmit the selected vehicle status information to the external operational data server 440.

The UBI terminal device 410 may select the information needed for the usage-based insurance service among the vehicle status information collected from the OBD terminal in the vehicle 10 based on the insurance information provided from the mobile device 420 and may transmit the selected vehicle status information to the operational data server 440.

In addition, the UBI terminal device 410 may generate the selected vehicle status information and the driving information based on the insurance information and the identification information ID, which are provided from the mobile device 420, and may transmit the selected vehicle status information and the driving information to the operational data server 440 according to the set transmission cycle.

Since the UBI terminal device 410 has been described with reference to FIGS. 1 to 3, details thereof will be omitted hereinafter.

The mobile device 420 is paired with the UBI terminal device 410 to transmit the authentication result and the insurance information.

In this case, the mobile device 420 executes the application of the insurance company downloaded from the App store 421 by the user, and the mobile device 420 transmits and receives the data to and from the UBI terminal device 410 through the application, performs the authentication process with the authentication server 430, and transmits the data to the operational data server 440. The application of the insurance company may be an application of an insurance company with which the user (the owner) of the vehicle has made a car insurance contract.

According to embodiments, the mobile device 420 may be a terminal device, such as a personal computer, a notebook computer, a smartphone, a tablet computer, or a wearable computer, owned by the user, and may perform operations throughout the service, such as a service screen configuration, a data input, a data transmission and reception, a data storage, and an authentication, under control of a web/mobile site or a dedicated application. In addition, the mobile device 420 used herein may indicate the application of the insurance company, which is downloaded and installed in the mobile device 420.

Referring to FIG. 4, the mobile device 420 may transmit the vehicle status information and the vehicle identification number, which are provided from the UBI terminal device 410 through the Bluetooth, to the authentication server 430 and may perform the authentication process based on the identification information ID received thereto according to the result of the authentication server.

In addition, the mobile device 420 may receive the insurance information of the insured vehicle from the authentication server 430 based on the authentication result and may transmit at least one of the received insurance information, the identification information, and the device information of the mobile device 420 to the UBI terminal device 410.

The authentication server 430 extracts the insurance information using the vehicle status information and the vehicle identification number (VIN), which are provided from the mobile device 420.

In this case, the authentication server 430 may be a server operated by the insurance company with which the user (the owner) of the vehicle 10 has made the car insurance contract and may store the insurance information, the identification information, the user information, and the device information for each vehicle identification number of the vehicles therein, to be matched with each other.

For example, the authentication server 430 may receive the vehicle status information and the vehicle identification number of the vehicle 10 from the mobile device 420 and may extract the insurance information and the identification information ID of the insured vehicle 10 from the received information. In this case, the identification information may be information used to identify the insurance of the insured vehicle and may be generated in accordance with the user information, the insurance information, and the vehicle identification number.

The operational data server 440 receives the selected vehicle status information needed for the usage-based insurance service from the UBI terminal device 410.

In this case, the operational data server 440 may receive the vehicle status information and the driving information from the UBI terminal device 410 and may store and maintain the received information to correspond to at least one of the vehicle identification number of the vehicle 10, the device information of the mobile device, and the user information. In addition, the operational data server 440 may apply the vehicle status information and the driving information to the insurance of the insured vehicle 10 using the information provided from the UBI terminal device 410 and may use the vehicle status information and the driving information for post-processing when the events occur. The events indicate a situation in which the usage-based insurance service according to the insurance information may be provided, i.e., events or accidents.

According to embodiments, it is preferred that the vehicle status information and the driving information generated by the UBI terminal device 410 are directly transmitted to the operational data server 440, however, the vehicle status information and the driving information may be transmitted to the operational data server 440 through the mobile device 420.

The authentication server 430 and the operational data server 440 shown in FIG. 4 are servers operated by the insurance company, and the authentication server 430 and the operational data server 440 may be operated as a single server rather than in a separate form.

In addition, the data in the UBI system 400 according to the exemplary embodiment of the present inventive concept may be transmitted or received through a wireless data communication, such as an Ethernet/3G, 4G, 5G, the Bluetooth, and the LoRa network, but the communication method and module should not be limited thereto or thereby.

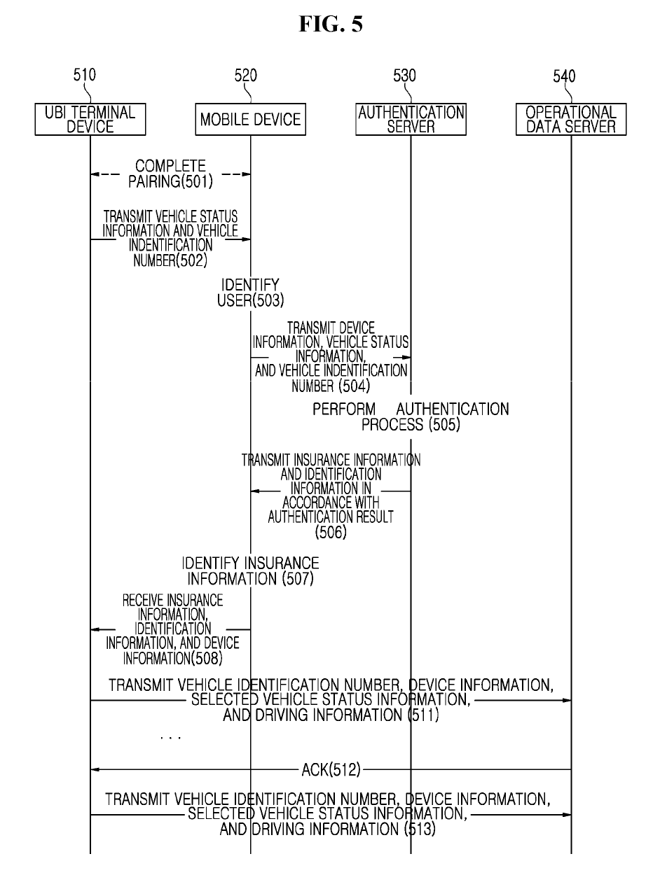

FIG. 5 is a view showing an operation flow between a UBI terminal device, a mobile device, an authentication server, and an operational data server according to an exemplary embodiment of the present inventive concept.

The UBI system according to the exemplary embodiment of the present inventive concept may include a plurality of UBI terminal devices, a plurality of mobile devices, a plurality of authentication servers, and a plurality of operational data servers, however, for the sake of clarity, a UBI terminal device 510, a mobile device 520, an authentication server 530, and an operational data server 540 are described in the singular.

For example, the UBI terminal device 510, the authentication server 530, and the operational data server 540 may exist for each insurance company, and the mobile device 520 may exist for each driver who drives the vehicle.

The user (the driver or owner of the vehicle) selects the insurance policy related to the vehicle and submits a vehicle registration certificate to the insurance company. In this case, the insurance company may store the user information, the device information of the mobile device 520, and the vehicle identification number of the vehicle and may store the device information of the mobile device 520 owned by each family member to be associated with the vehicle identification number of the vehicle when the user is limited to a married couple or family member(s).

In addition, the user installs the UBI terminal device 510 provided from the insurance company in the vehicle. In this case, the insurance company may include the authentication server 530 and the operational data server 540.

Referring to FIG. 5, in operation 501, the UBI terminal device 510 and the mobile device 520 are paired to each other. In this case, the mobile device 520 may be located inside the vehicle and may be a device in which the insurance company's application is installed.

For instance, when the user turns on the vehicle and activates the application installed in the mobile device 520, the UBI terminal device 510 and the mobile device 520 are paired to each other through the Bluetooth. According to embodiments, in a case where the Bluetooth of the mobile device 520 is inactivated, the application in the mobile device 520 may push a message to activate the Bluetooth.

When the pairing between the UBI terminal device 510 and the mobile device 520 are completed, the UBI terminal device 510 may provide the output information with respect to a current operation (e.g., a connection completion) through the LED.

Then, in operation 502, the UBI terminal device 510 transmits a mileage of the vehicle provided through the OBD, the vehicle status information including a total mileage, and the vehicle identification number (VIN) of the vehicle to the mobile device 520.

In this case, the mobile device 520 corresponds to a terminal device carried by the driver who drives the vehicle, and the authentication server 530 and the operational data server 440 may determine the driver depending on the device information of the mobile device. For example, since a couple or family member(s) may drive a single vehicle, the authentication server 530 and the operational data server 440 may identify the driver who currently drives the vehicle through the mobile device 520.

That is, the mobile device 520 identifies the user who drives the vehicle (operation 503).

Then, in operation 504, the user checks whether the vehicle status information of the vehicle matches with the mileage displayed through the application in the mobile device 520 and then pushes a transmission button. Then, the mobile device 520 transmits the data including the device information of the mobile device 520, the vehicle identification number, and the vehicle status information to the authentication server 530 in accordance with the user's selection input.

In operation 505, the authentication server 530 checks whether the user is included in the insurance policy on the basis of the receive data. For example, when the user is not included in the insurance policy, the authentication server 530 transmits an error message to the mobile device 520 to terminate the application. However, when the user in included in the insurance policy, the authentication server 530 stores the received data and transmits the identification information ID according to the insurance policy (insurance information) of the user to the mobile device 520 (operation 506).

Accordingly, the user checks the identification information ID through the mobile device 520 and identifies the insurance information corresponding to the vehicle (operation 507).

Then, in operation 508, the mobile device 520 transmits at least one of the insurance information, the identification information, and the device information of the mobile device 520 to the UBI terminal device 510. The authentication process ends with this operation.

When the authentication process is completed, the mobile device 520 may receive the service for the usage-based insurance that matches the insurance information of the user. In addition, the UBI terminal device 510 receives the identification information according to the insurance information of the user and generates the data including at least one of the vehicle identification number, the device information of the mobile device 520, the selected vehicle status information, and the driving information to transmit the data to the operational data server 540 at the transmission cycle corresponding to the identification information (operation 511). In the present exemplary embodiment, the data may include the location information of the vehicle obtained from the GPS module, the event information obtained by processing the input through the accelerometer Acc, and the vehicle status information (or vehicle driving data) obtained through the OBD.

In this case, the selected vehicle status information may be the vehicle status information needed for the service for the usage-based insurance among the vehicle status information collected from the OBD terminal in the vehicle on the basis of the insurance information of the user. That is, the selected vehicle status information may be generated differently for each insurance information of the user and the vehicle type and may be generated for each user who drives the vehicle.

The UBI system according to the exemplary embodiment of the present inventive concept allows the UBI terminal device 510 to transmit the vehicle identification number, the device information, the selected vehicle status information, and the driving information to the operational data server 540 and allows the operational data server 540 to transmit an ACK corresponding to the received information (operation 512) based on the authentication result. Then, the data transmission and reception may be performed between the UBI terminal device 510 and the operational data server 540. The data transmission process is completed with this operation.

According to embodiments, the authentication server 530 may be connected to the operational data server 540. If necessary, the authentication server 530 may request the data from the UBI terminal device 510 through the operational data server 540. In this case, the operational data server 540 may directly request the data from the UBI terminal device 510, and the UBI terminal device 510 may transmit corresponding data to the operational data server 540.

According to the present inventive concept, when the user turns off the vehicle after the authentication process and the data transmission process, then turns on the vehicle again, and operates the corresponding application in the mobile device 520, the application is automatically paired with the UBI terminal device 510.

Then, when the pairing is completed, the data transmission process may be directly performed without performing the authentication process. For instance, the UBI terminal device 510 may transmit the data including the vehicle identification number and the device information (or phone #) of the mobile device 520 to the operational data server 540. However, in a case where the user does not operate the application in the mobile device 520 after the authentication process is completed, the data transmission process may be performed using the device information of the mobile device 520, which includes the phone # or a Null phone #, which is last stored.

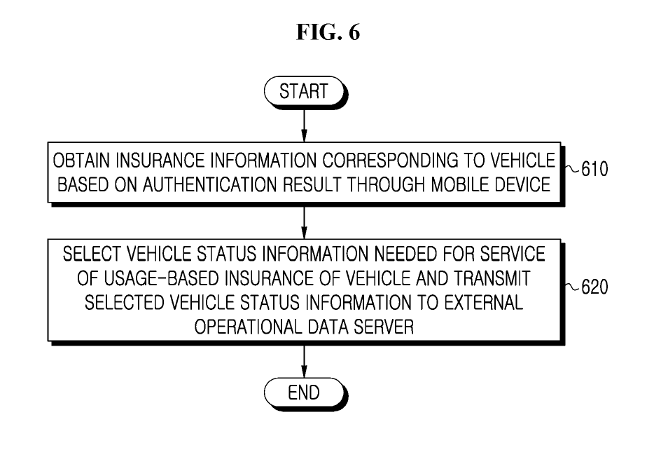

FIG. 6 is a flowchart showing an operation method of a UBI terminal device according to an exemplary embodiment of the present inventive concept.

The operation method shown in FIG. 6 may be performed by the UBI terminal device according to the exemplary embodiment of the present inventive concept shown in FIG. 1.

Referring to FIG. 6, in operation 610, the insurance information corresponding to the vehicle is obtained from the mobile device based on the authentication result through the mobile device in the vehicle.

For example, operation 610 may include paring (not shown) with the mobile device, transmitting (not shown) the vehicle status information and the vehicle identification number (VIN), which are collected from the OBD terminal in the vehicle after being connected to the OBD terminal, to the mobile device, and receiving (not shown) at least one of the insurance information of the insured vehicle, the identification information, and the device information of the mobile device from the mobile device based on the authentication result.

In this case, the insurance information is the information related to the insurance of the vehicle insured with the insurance company, and the service for the usage-based insurance may include a service needed to maintain and manage the insurance corresponding to the insurance information or a service provided to the vehicle when the events occur. In addition, the authentication result may be the result obtained by the authentication process between the mobile device and the authentication server based on the vehicle status information and the vehicle identification number, and the insurance company may include the authentication server and the operational data server.

In the present exemplary embodiment, the identification information is the data with respect to the insurance information of the insurance policy of the insured vehicle, and the insurance information may be verified using the identification information in operation 610.

In operation 620, the vehicle status information needed for the service for the usage-based insurance of the vehicle is selected and transmitted to the external operational data server based on the insurance information.

Operation 620 may include selecting (not shown) the vehicle status information collected from the OBD terminal in the vehicle and the information needed for the service for the usage-based insurance based on the insurance information provided from the mobile device and transmitting (not shown) the selected vehicle status information to the operational data server.

In this case, operation 620 may be operation that generates the selected vehicle status information and the driving information according to the set transmission cycle required by the insurance service of the insured vehicle based on the insurance information and the identification information ID, which are provided from the mobile device, and transmits the vehicle status information and the driving information to the operational data server.

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or more software applications running on the OS. Further, the processing unit may access, store, manipulate, process and generate data in response to execution of software. It will be understood by those skilled in the art that although a single processing unit is illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory(CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described exemplary embodiments of the inventive concept, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implementations, other embodiments and within the scope of the claims to be described later things by the claims and equivalents.

What is claimed is:

1. A usage-based insurance terminal device comprising:
an authentication processor obtaining an insurance information corresponding to a vehicle from a mobile device based on an authentication result through the mobile device in the vehicle; and
a data transmitter selecting a vehicle status information needed for a service for a usage-based insurance of the vehicle based on the insurance information and transmitting the vehicle status information to an external operational data server.

2. The usage-based insurance terminal device of claim 1, wherein the data transmitter transmits the vehicle status information and a vehicle identification number, which are collected from an on-board diagnostics terminal in the vehicle after being connected to the on-board diagnostics terminal, to the mobile device paired therewith.

3. The usage-based insurance terminal device of claim 2, wherein the mobile device transmits the vehicle status information and the vehicle identification number to an authentication server and executes an authentication process based on an identification information provided from the authentication server.

4. The usage-based insurance terminal device of claim 3, wherein the authentication processor receives at least one of the insurance information of the vehicle that is insured, the identification information, and a device information of the mobile device from the mobile device through the authentication server based on the authentication result.

5. The usage-based insurance terminal device of claim 1, wherein the insurance information is an information related to an insurance of the vehicle insured with an insurance company, and the service for the usage-based insurance comprises a service for maintaining and managing the insurance corresponding to the insurance information or a service provided to the vehicle when events occur.

6. The usage-based insurance terminal device of claim 1, wherein the data transmitter selects an information needed for the service for the usage-based insurance (UBI) among the vehicle status information collected from an on-board diagnostics terminal in the vehicle based on the insurance information and transmits the selected vehicle status information to the operational data server.

7. The usage-based insurance terminal device of claim 6, wherein the data transmitter generates the selected vehicle status information and a driving information and transmits the selected vehicle status information and the driving information to the operational data server according to a set transmission cycle based on the insurance information provided from the mobile device and an identification information.

8. A usage-based insurance system comprising:
a usage-based insurance terminal device executing an authentication process with a mobile device in a vehicle, selecting a vehicle status information needed for a service for a usage-based insurance of the vehicle from an insurance information according to the authentication result, and transmitting the selected vehicle status information to an external operational data server;
the mobile device paired with the usage-based insurance terminal device to transmit the authentication result and the insurance information;
an authentication server extracting the insurance information using the vehicle status information and a vehicle identification number of the vehicle, which are provided from the mobile device; and
the operational data server receiving the selected vehicle status information needed for the service for the usage-based insurance from the usage-based insurance terminal device.

9. The usage-based insurance system of claim 8, wherein the mobile device transmits the vehicle status information and the vehicle identification number, which are provided from the usage-based insurance device, to the authentication server and executes the authentication process based on an identification information received according to a review of the authentication server.

10. The usage-based insurance system of claim 9, wherein the mobile device receives the insurance information of the vehicle that is insured from the authentication server based on the authentication result and transmits at least one of the received insurance information, the identification information, and a device information of the mobile device to the usage-based insurance terminal device.

11. The usage-based insurance system of claim 8, wherein the usage-based insurance terminal device selects an information needed for the service for the usage-based insurance among the vehicle status information collected from an on-board diagnostics terminal in the vehicle based on the insurance information provided from the mobile device and transmits the selected vehicle status information to the operational data server.

12. The usage-based insurance system of claim 11, wherein the usage-based insurance terminal device generates the selected vehicle status information and a driving information and transmits the selected vehicle status information and the driving information to the operational data server according to a set transmission cycle based on the insurance information provided from the mobile device and an identification information.

13. An operation method of a usage-based insurance terminal device, comprising:
a first operation for obtaining an insurance information corresponding to a vehicle from a mobile device based on an authentication result through the mobile device in the vehicle; and
a second operation for selecting a vehicle status information needed for a service for a usage-based insurance of the vehicle based on the insurance information to transmit the vehicle status information to an external operational data server.

14. The method of claim 13, wherein the first operation comprises:
pairing with the mobile device;
transmitting the vehicle status information and a vehicle identification number, which are collected from an on-board diagnostics terminal in the vehicle after being connected to the on-board diagnostics terminal, to the mobile device; and
receiving at least one of the insurance information of the vehicle that is insured, an identification information, and a device information of the mobile device from the mobile device based on the authentication result.

15. The method of claim 14, wherein the authentication result is obtained by an authentication process between the mobile device and the authentication server based on the vehicle status information and the vehicle identification number.

16. The method of claim 13, wherein the second operation comprises:
selecting an information needed for the service for the usage-based insurance among the vehicle status information collected from an on-board diagnostics terminal in the vehicle based on the insurance information provided from the mobile device; and
transmitting the selected vehicle status information to the operational data server.

17. The method of claim 16, wherein the selecting of the needed information comprises generating the selected vehicle status information and a driving information according to a set transmission cycle based on the insurance information and an identification information, which are provided from the mobile device.

18. A computer program stored in a computer-readable recording medium for executing a method of claim 13.
